(19) United States
(12) Patent Application Publication
(10) Pub. No.: US 2015/0287007 A1
(43) Pub. Date: Oct. 8, 2015

(54) SYSTEM AND METHOD FOR ADAPTED VENDING SOLUTIONS

(71) Applicant: Mallianath Suralikal, Santa Clara, CA (US)

(72) Inventors: Mallinath Suralikal, Santa Clara, CA (US); Bharathi Suralikal, Santa Clara, CA (US)

(21) Appl. No.: 14/678,962

(22) Filed: Apr. 4, 2015

Related U.S. Application Data
(60) Provisional application No. 61/975,775, filed on Apr. 5, 2014.

(51) Int. Cl. G06Q 20/18; G06Q 20/40; G06Q 20/32

(52) U.S. Cl. CPC G06Q 20/18; G06Q 20/325; G06Q 20/40

(57) ABSTRACT

A system for adapted vending solutions. A remote server is communicably coupled to a vending adapter module via an Internet router and to a user computing device. The vending machine adapter module is communicably coupled to the user computing device and is configured to control a vending machine. The vending machine adapter module comprises Wi-Fi and Bluetooth communication circuitry configured to transmit vending requests and receive vending authorization instructions from a vending service and to detect and identify the user computing device and receive vending requests from the user computing device; power supply control circuitry configured to enable or disable power to the vending machine in response to instructions received from the remote server; a sensor network; and vending control circuitry configured to enable vending by the vending machine in response to instructions received from one of the remote server or the vending service.

### CLAIM OF PRIORITY

The present application claims the benefit of and priority to U.S. Provisional Application No. 61/975,775 titled “HIGH TECH MEMBER VENDING SYSTEM” filed on Apr. 5, 2014, the entirety of which is hereby incorporated by reference herein.

### COMPUTER PROGRAM LISTING APPENDIX

A computer program listing appendix labeled Appendix.txt is provided via EFS with this application. The information is hereby incorporated by reference as if set forth in full in this application for all purposes. A portion of the disclosure recited in this application contains material which is subject to copyright protection. Specifically, the computer program listing appendix and possibly other portions of the application may recite or contain source code, data or other functional text. The copyright owner has no objection to the facsimile reproduction of the functional text; otherwise all copyright rights are reserved.

### BACKGROUND OF THE INVENTION

The present invention relates generally to vending machine systems and methods and more specifically to a system for adapted vending solutions.

A coin-operated machine allows a user to insert a designated amount of coins to receive a product or service offered by the machine. The coin-operated machine can be a vending machine, laundry machine, fuel dispenser, and the like.

An operator typically attends to coin-operated machines in order to at least collect all of the coins that have been inserted into the machine since the last operator visit. When the inventory is low, the operator must also monitor inventory and restock when necessary. The operator also monitors functionality to ensure the machine is in working order; otherwise the operator must schedule or perform maintenance.

A user begins by inserting one or more coins into the coin-operated machine to initiate operation and receive a product or service from the coin-operated machine. After a required number of coins is inserted, the machine is initiated and begins to dispense the requisite product or service.

Sometimes, a user might insert a coin only to realize that the user is not carrying additional coins needed to start the machine. The user then temporarily proceeds to a change machine or a counter attendant to obtain additional coins for insertion into the machine. At other times, the user may be unable to find change and may then discontinue using the coin-operated machine.

Yet, at other times, as the user begins to insert the coin, it may become jammed in the machine. If a service attendant is around, the attendant can unclog the machine to remove the coin; otherwise the user may need to discontinue use of the machine.

Further yet, at other times, upon arriving at the coin-operated machine or after inserting the requisite amount of coins, the machine might be unable to dispense a product or service because there is no inventory or because the coin-box is full and has not been emptied by the operator.

The user may also use a card to obtain a product or service from the card operated machine. The user inserts the card, and the machine reads the card to deduct an appropriate amount. At other times, the user may arrive at the card machine only to realize that the user does not have the card. The user may then begin searching for the card; and if the card is misplaced, the loss is then reported to the operator.

It is within the aforementioned context that a need for the present invention has arisen. Thus, there is a need to address one or more of the foregoing disadvantages of conventional systems and methods, and the present invention meets this need.

### BRIEF SUMMARY OF THE INVENTION

Various aspects of methods and systems for adapted vending solutions can be found in exemplary embodiments of the present invention.

In a first embodiment, a remote server is communicably coupled to a vending machine adapter module adapted to operate a vending machine. Specifically, the vending machine adapter module is communicably coupled to a user computing device and is configured to control the vending machine. The vending machine adapter module comprises Wi-Fi and Bluetooth communication circuitry configured to transmit vending requests and receive vending authorization instructions from a vending service and to detect and identify the user computing device and receive vending requests from the user computing device. The vending machine adapter module also comprises 1 scan circuitry configured to scan a code identifying vending credits; power supply control circuitry configured to enable or disable power to the vending machine in response to instructions received from the remote server; a sensor network; and vending control circuitry configured to enable vending by the vending machine in response to instructions received from one of the remote server or the vending service.

With the present invention, a user can utilize a mobile application on a mobile computing device to register with a vending service and obtain vending credits. The user can then use the mobile computing device to communicate a vending request to a vending machine. The vending machine is adapted to communicate with a remote server to obtain authentication of the user, and the remote server communicates with a vending service to authorize vending of the product or service by the vending machine. The vending machine vends in response to instructions received from the remote server or the vending service, and the cost of the vend is deducted from the users vending credits by the remote server or the vending service.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1 illustrates an adapted vending system according to an exemplary embodiment of the present invention.

FIG. 2A illustrates adapted vending system communication according to an exemplary embodiment of the present invention.

FIG. 2B illustrates adapted vending system communication according to an exemplary embodiment of the present invention.

FIG. 3 illustrates a vending machine adapter module according to an exemplary embodiment of the present invention.

FIG. 4 illustrates a sensor network for use with an exemplary embodiment of the present invention.

FIG. 5A illustrates control logic for use with an exemplary embodiment of the present invention.

FIG. 5B illustrates control logic for use with an exemplary embodiment of the present invention.

FIG. 5C illustrates control logic for use with an exemplary embodiment of the present invention.

FIG. 5D illustrates control logic for use with an exemplary embodiment of the present invention.

FIG. 6 illustrates a remote server system for use with an exemplary embodiment of the present invention.

FIG. 7 illustrates control circuitry according to an exemplary embodiment of the present invention.

FIG. 8 illustrates an exemplary computer architecture for use with an exemplary embodiment of the present invention.

FIG. 9 illustrates a block diagram of a merchant side application according to an exemplary embodiment of the present invention.

FIG. 10 illustrates a block diagram of a remote server side application according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth to provide a thorough understanding of the present invention. However, it will be obvious to one of ordinary skill in the art that the present invention may be practiced without these specific details. In other instances, well-known methods, procedures, components, and circuits have not been described in detail as to not unnecessarily obscure aspects of the present invention.

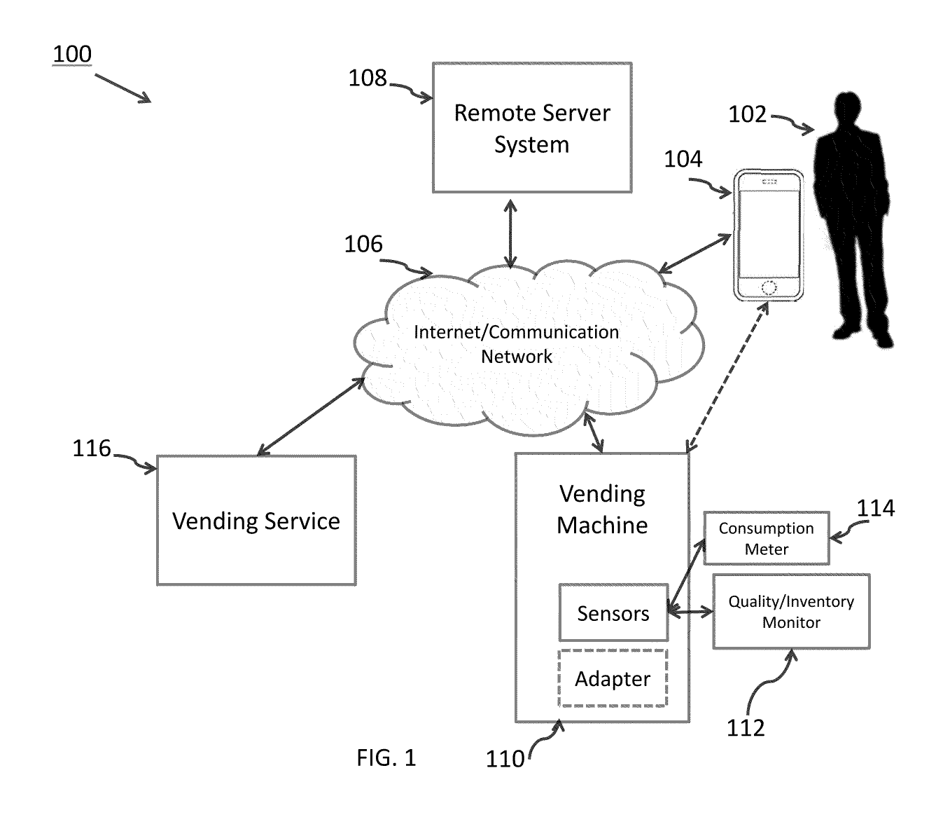

FIG. 1 illustrates an adapted vending system 100 according to an exemplary embodiment of the present invention.

In FIG. 1, adapted vending system 100 comprises a user 102 having a mobile computing device 104 communicably coupled via Internet/communication network 106 to vending service 116. Internet/communication network 106 can be any communication network that allows data to be communicated or transferred from one point to another. Such a network might be wired or wireless as deemed necessary to be consistent with the spirit and scope of the present invention.

In FIG. 1, user 102 can utilize a mobile application (not shown here) on mobile computing device 104 to access remote server system 108 to register with remote server system 108 and vending service 116, and to obtain vending credits. User 102 utilizes the mobile application to communicate with vending machine 110, whereby the user 102 requests vending of products or services provided by the vending machine 110.

Here user 102 may be any user that wishes to purchase a product from a vending machine. For example, user 102 might wish to utilize coins to vend water from a vending machine. As another example, user 102 might be an entity that wishes to pay to launder clothing at a Laundromat.

Vending service 116 is a collective or membership that grants, issues and tracks vending credits that users can use to purchase items from vending machines. Although not shown, vending service 116 includes one or more computers, databases and corresponding one or more lines of software code that may be completely incorporated within remote server system 108. Or vending service 116 may be incorporated partly locally within the vending machine adapter module as middleware and/or partly remotely incorporated within remote server system 108.

Vending service 116 may also be completely local or completely remote separate and apart from remote server system 108. Thus, during or after user registration, payments received from the user (e.g., at a merchant location where the user wishes to vend a product) are entered and stored for tracking by vending service 116.

In FIG. 1, vending system 100 further comprises vending machine 110 also communicably coupled to user 102 having mobile computing device 104 via Internet/communication network 106. Vending machine 110 includes circuitry (not shown here) and sensors such that a consumption meter 114 can monitor consumption at the vending machine 110. Vending machine 110 also includes circuitry (not shown here) and sensors such that a monitor 112 can observe and report on product quality and inventory.

In FIG. 1, vending machine 110 can include an adapter that comprises computing components. The adapter can be embedded in vending machine 110, or can be installed in an existing machine. The adapter scans code or receives the data from the user 102 using mobile computing device 104 or a printed card having a QR code. The adapter also receives sensor data. The adapter can provide instructions to the vending machine 110 based on received data and existing logic contained within the adapter. The adapter can also comprise sensors and the consumption meter 114 and quality/inventory monitor 112.

User 102 can then perform functionalities related to vending consistent with the spirit and scope of the present invention. Although not shown, further descriptions of various embodiments of the present invention will be described with reference to the following figures.

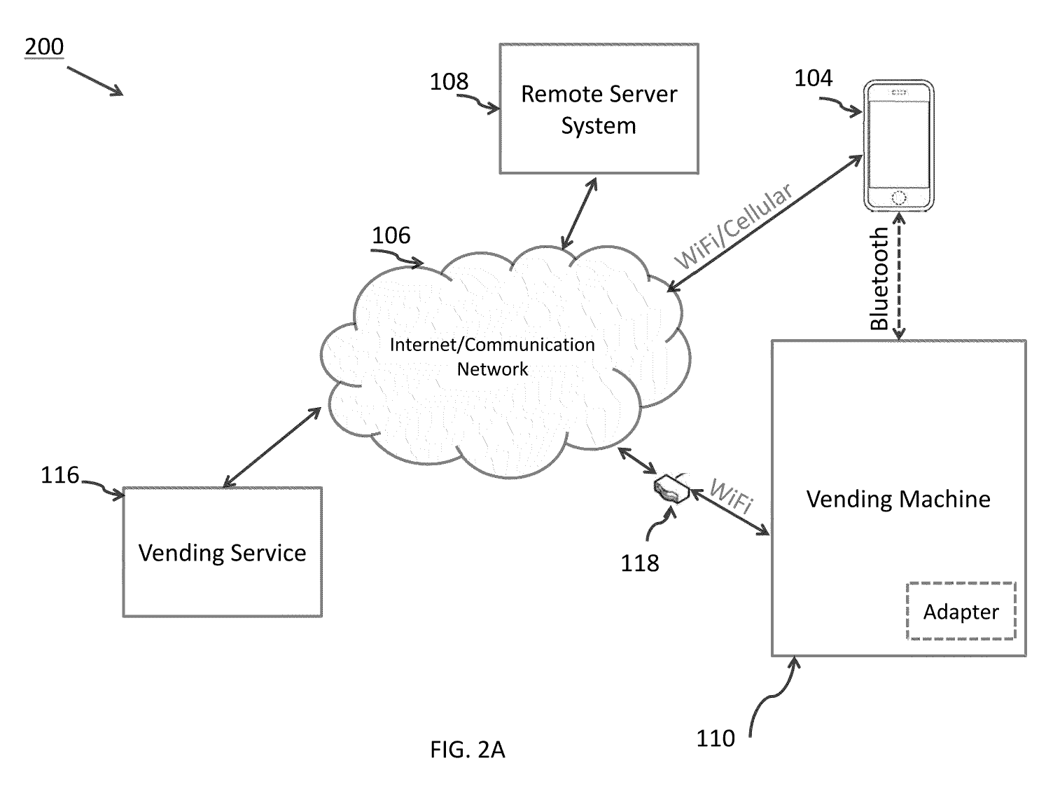

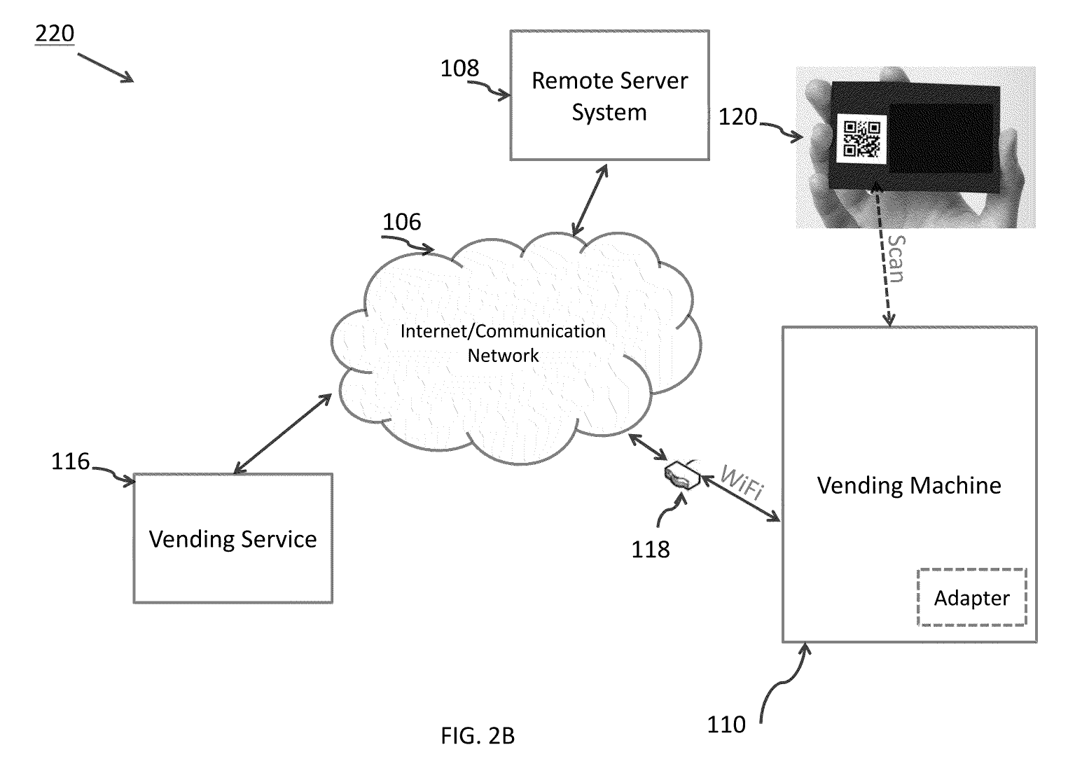

FIG. 2A illustrates adapted vending system communication 200 according to an exemplary embodiment of the present invention.

In FIG. 2A, a mobile computing device 104 is communicably coupled with vending machine 110 via Internet/communication network 106. Vending machine 110 includes circuitry (not shown) to enable communication via Bluetooth as well as Wi-Fi. Vending machine 110 can communicate via Bluetooth, Wi-Fi, or a scanner with mobile computing device 104. Vending machine 110 is also communicably coupled with remote server system 108 through router 118 via Internet/communication network 106. Vending machine 110 and mobile computing device 104 are also communicably coupled with vending service 116 via Internet/communication network 106. Mobile computing device 104 is also communicably coupled via Internet/communication network 106 with remote server system 108. Mobile computing device may be coupled via cellular or Wi-Fi.

Router 118 receives data from Internet/communication network. Router 118 is a Wi-Fi router capable of receiving data from the Internet and that is compliant with 802.11 standards. Router 118, as mentioned, is capable of receiving data from Internet/communication network 106 and transmitting received data to vending machine 110.

FIG. 2B illustrates adapted vending system communication 220 according to an exemplary embodiment of the present invention.

In FIG. 2B, vending machine 110 includes circuitry (not shown) to enable communication via Bluetooth as well as Wi-Fi. Vending machine 110 also includes scanning capability in order to scan a code (e.g., QR code) from card 120. Vending machine can connect to router 118 and communicate over Internet/communication network 106 with remote server system 108 and vending service 116.

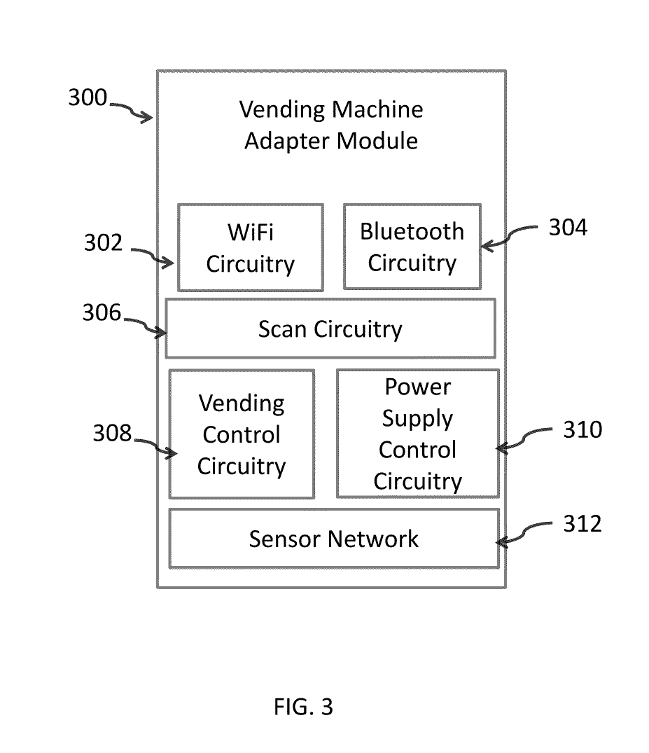

FIG. 3 illustrates vending machine adapter module 300 according to an exemplary embodiment of the present invention.

In FIG. 3, vending machine adapter module 300 includes Wi-Fi circuitry 302 and Bluetooth circuitry 304 that enable communication via Wi-Fi and Bluetooth, respectively. Wi-Fi circuitry 302 can receive or transmit data to and from router 118 of FIG. 1. Specifically, Wi-Fi circuitry 302 processes remote commands received from users via Internet/Communication network 106 and router 118 before being processed at adapter module 300.

Vending machine adapter module 300 is communicably coupled to one or more sensors that are part of a sensor network 312. Vending machine adapter module 300 can receive data from sensor network 312, as will be described more fully below, and push such data via router 118 and Internet/communication network 106 to the remote server system 108 of FIG. 1. Such data might include water quality data, for example.

In FIG. 3, vending machine adapter module 300 comprises vending control circuitry 308 that enables or disables the vending functionality. Vending machine adapter module 300 also comprises power supply control circuitry 310 that enables or disables power to the entire vending machine.

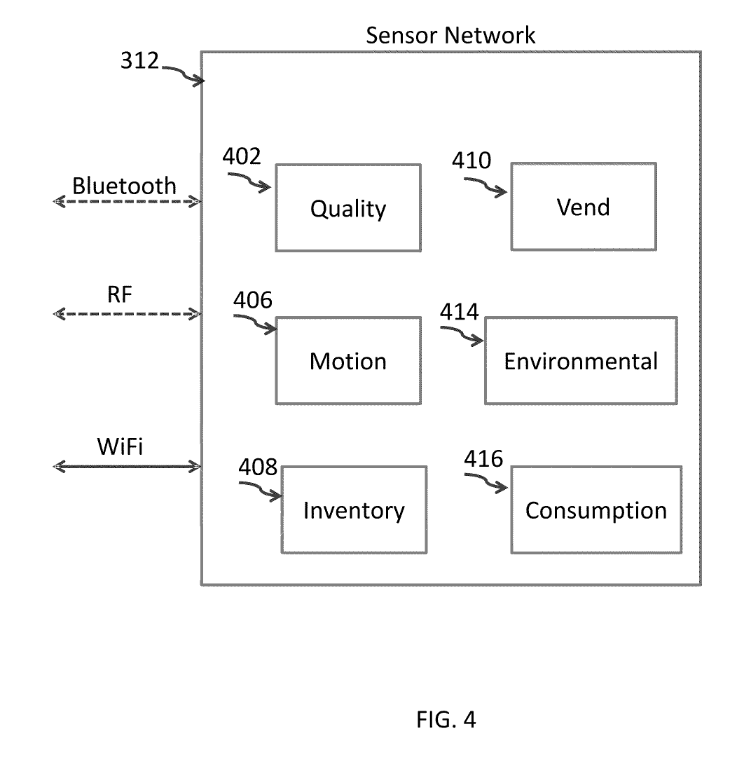

FIG. 4 illustrates a sensor network 312 according to an exemplary embodiment of the present invention.

In FIG. 4, sensor network 312 comprises one or more sensors to monitor one or more types of information related to the vending system. Sensor network 312 comprises one or more sensors that have varying communication capabilities, including one or more of Bluetooth, RF, and Wi-Fi capabilities.

A motion sensor 406 detects motion near the vending system. A motion sensor 406 can provide power savings in the event the vending system is powered down during periods of inactivity. Vending sensor 410 provides an indication of a successful vend. Information regarding unsuccessful vends can reveal a vending system that is not functioning properly.

Quality sensor(s) 402 monitor the quality of the product being dispensed. For example, if the product is water, quality sensor(s) 402 repeatedly measure such characteristics as electrical conductivity, of water in a water line, with repeated values been taken and averaged to provide a continuous display of the condition of water in the line. Each new value is compared to a reference value such as a government standard representing a maximum acceptable level of contaminants. If the water quality value exceeds the reference value, an alarm signal is generated indicating an unacceptable level of contaminants in the water.

Quality sensor(s) 402 can provide useful data not only for maintenance purposes, but also for potential government audits. Somewhat related to quality sensor(s) 402, environmental sensor(s) 414 monitor the environment surrounding the vending system. This information can be used for knowing when to replace goods sensitive to temperature, pressure, or sunlight, for example.

Inventory sensor(s) 408 and consumption sensor(s) 416 are somewhat related in that they monitor what remains in the vending system and what has been dispensed from the vending system, respectfully. Consumption sensor(s) 416 may also keep track of consumption by a particular user at the time of vending.

It will be appreciated that sensor network 312 can comprise any number and combination of sensors without departing from the scope of the present invention.

Use and operation of the present invention will now be described with reference to FIGS. 1, 2A-B, 3 and 4. Vending machine adapter module 300 of the present invention is installed in a pre-existing vending machine 110. Once the adapter module 300 is installed, the user is ready to begin utilization of the present invention.

In FIG. 1, user 102 registers with remote server system 108 and vending service 116 via either a web interface (not shown) or an installed mobile application (not shown) using mobile computing device/client computing device 104. Once registered, user 102 can purchase vending credits associated with vending machine 110. The mobile computing device is adapted to communicate a consumer profile (not shown) of user 102 to the remote server system 108 and/or vending service 116.

In one embodiment, the consumer profile may include personal information such a name, address, email for registering user 102. Optionally or in addition, the consumer profile may include payment information, a credit card, a desired merchant, a product type such as water, laundry, beverages, or the product type to be dispensed from a particular vending machine. Where there are a number of vending machines (or other selectable variables such as the number of gallons of water to vend) in a single location, selection of the particular machine for dispensing can be done via the consumer profile or locally via the vending machine adaptor module software that selects the machine type, the amount of product and any local variables.

User 102 approaches vending machine 110 and device 104 is detected via Bluetooth by vending machine 110. Upon detection of device 104, the user enters a vending request into the vending machine 110.

In responsive to the user request, the vending machine adapter module sends a product vend request signal to the remote server. Specifically, vending machine 110 transmits a request for authentication of device 104 to remote server system 108, as well as the product vend request signal. Remote server system 108 authenticates the device 104 and transmits a vend request authorization signal to vending service 116.

Vending service 116 then transmits vending instructions signal/vending authorization signal to vending machine 110, and the instructions are executed. Here, note that the product vend request signal is based on a vending key generated by device 104. Specifically, after registration, user 102 receives an activation code. When that code is entered by user 102 into device 104, the remote server system 108 transmits a vending key to device 104. This vending key, in one embodiment, is then used to generate a QR code that also includes additional identifying data (e.g. the specific machine) that is used to generate the product vend request signal. The product vend request signal may also be based on the credits or payments made by user 102.

Execution of the vending instructions results in either a successful vend, or an error and no vend occurs. An error can occur due to authentication failure, vend authorization failure due to insufficient balance, or other error.

A confirmation of execution of vending instructions is transmitted to one or more of the remote server system 108 and the vending service 116.

An amount related to the vend transaction is deducted from the user 102's account at the remote server system 108. Consumption at the vending machine is recorded, as is inventory.

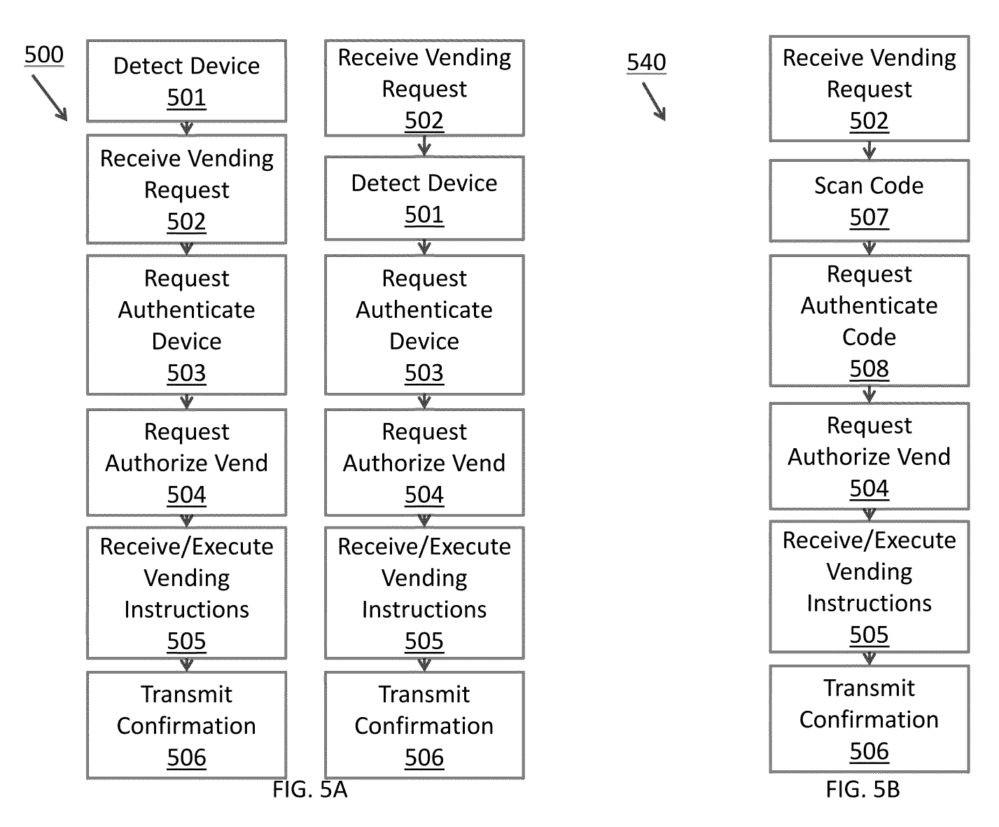

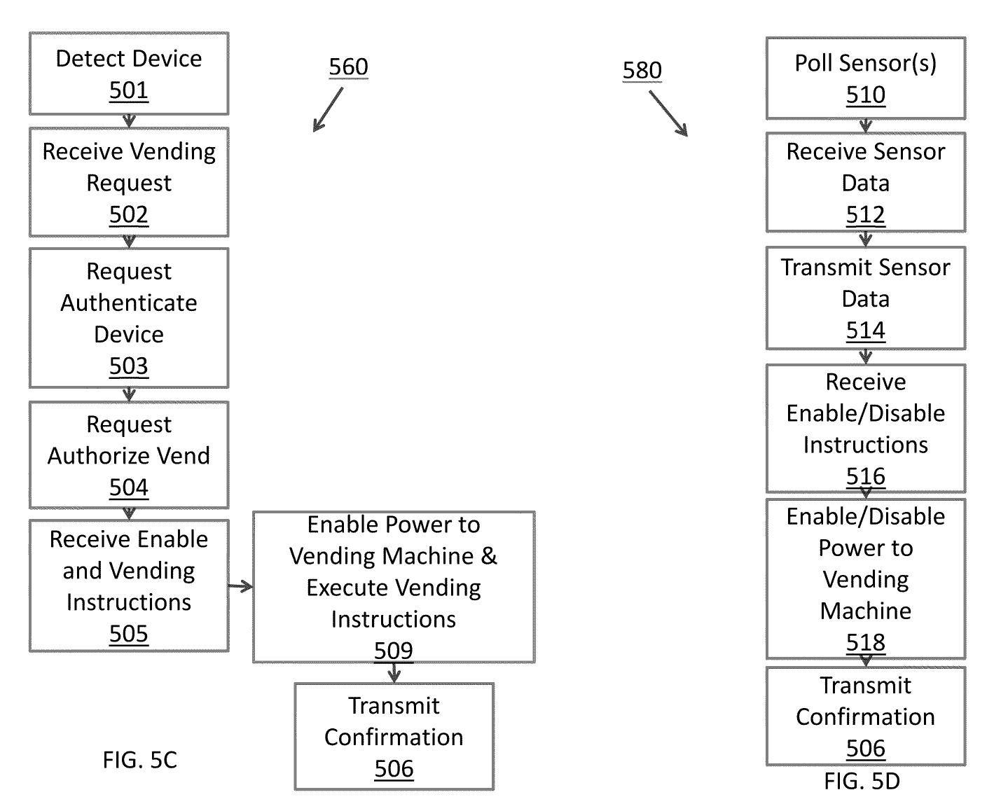

FIG. 5A illustrates control logic 500 according to an exemplary embodiment of the present invention.

In FIG. 5A, a device is detected 501 within proximity of the vending machine, and a vending request is received 502. The vending machine requests to the remote server system to authenticate the device 503, and requests authorization to fulfill the vending request 504. The remote server system transmits authorization to the vending service, and the vending machine receives vending instructions 505 from the vending service. The vending machine executes the vending instructions and transmits confirmation 506 of vending to one or more of the vending service and remote server system. It will be appreciated that the vending instructions can be one of vend and do not vend. It will also be appreciated that a vending request can be received 502 prior to detecting a device 501 within proximity.

FIG. 5B illustrates control logic 540 according to an exemplary embodiment of the present invention.

In FIG. 5B, a vending request is received 502 from the user. The vending request may be incorporated as part of a code provided to the user. The vending machine then scans a code 507 supplied by the user (e.g., a QR code on a card). The vending machine requests to the remote server system to authenticate the code 508, and requests from the vending service authorization to fulfill the vending request 504. The vending service determines among other functions whether there is sufficient credit for the user to vend. If so, the vending service transmits authorization to the remote server system transmits authorization to the vending service, and the vending machine receives vending instructions 505 from the vending service. The vending machine executes the vending instructions and transmits confirmation 506 of vending to one or more of the vending service and remote server system.

FIG. 5C illustrates control logic 560 according to an exemplary embodiment of the present invention.

In FIG. 5C, a device is detected 501 within proximity of the vending machine, and a vending request is received 502. The vending machine requests to the remote server system to authenticate the device 503, and requests authorization to fulfill the vending request 504. The remote server system transmits authorization to the vending service, and the vending machine receives vending instructions from the vending service and power supply enable instructions from the remote server system 520. Power is enabled to the vending machine 509 and the vending machine executes the vending instructions. A confirmation is transmitted 506 to one or more of the vending service and remote server system.

FIG. 5D illustrates control logic 580 according to an exemplary embodiment of the present invention.

In FIG. 5D, one or more sensors are polled 510 and sensor data is received 512 by the vending machine adapter module. The sensor data is transmitted 514 to the remote server system; the sensor data is transmitted either via Bluetooth to a mobile computing device which then transmits the sensor data to the remote server system, or directly through a router via Wi-Fi to the remote server system. The remote server system examines the sensor data and transmits instructions to the vending machine adapter module. The instructions received by the vending machine adapter module 516 can be one of enable power or disable power to the vending machine. The instructions are executed, meaning power is either enabled or disabled 518, and a confirmation is transmitted 506.

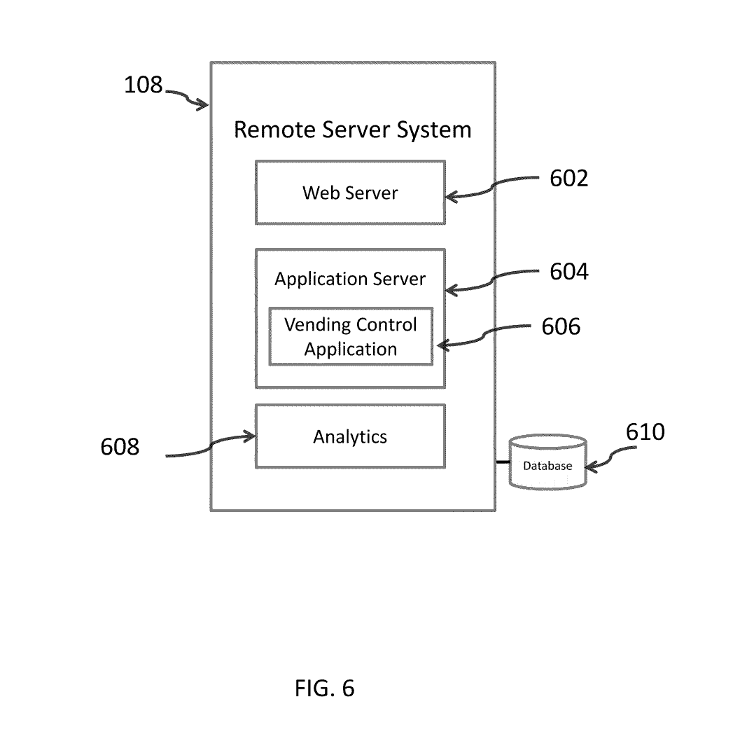

FIG. 6 illustrates remote server system 108 according to an exemplary embodiment of the present invention.

In FIG. 6, remote server system 108 includes web server 602 and application server 604. Web server 602 functions to serve up and host a website (not shown) that can be accessed by user 102 of FIG. 1. Among other functionalities, users can access this website to determine vending consumption and credit information. Web server 602 can be hardware, software or a combination of both.

Application server 604 controls all software applications accessible by user 102. User 102 can access a vending application (not shown), which includes one or more software instructions enabling a user to view vending consumption and credit information. Authentication server 606 provides authentication of devices, users, and scanned codes. Analytics server 608 aggregates all data received by remote server system. Servers 602, 604, 606 and 608 are communicably coupled to database 610, in which information for all registered users and vending machines are stored.

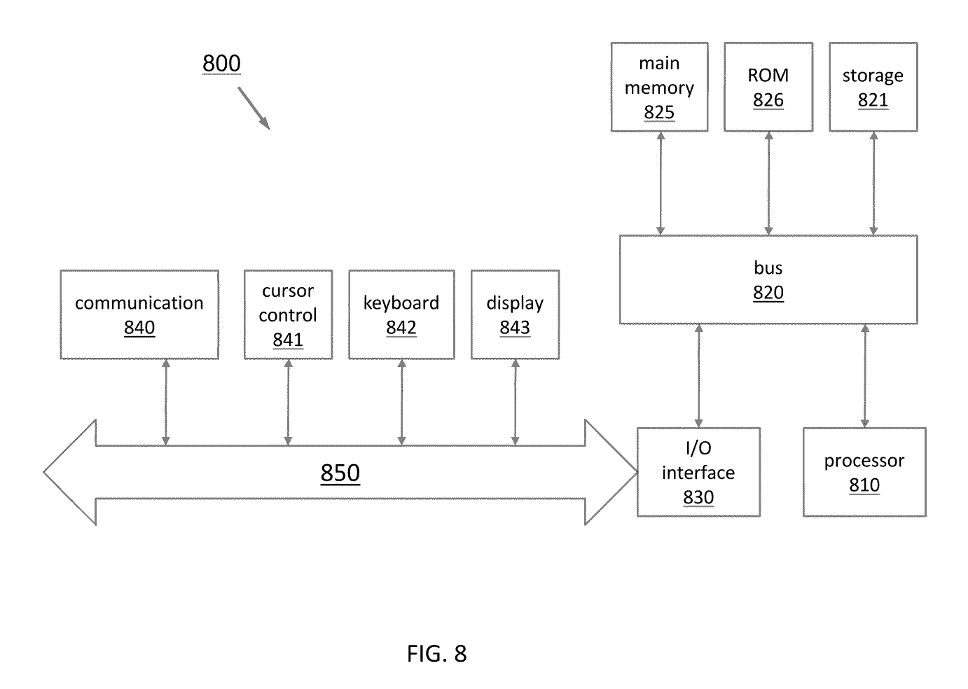

According to one embodiment, remote server system employs architectures similar to that depicted in FIG. 8.

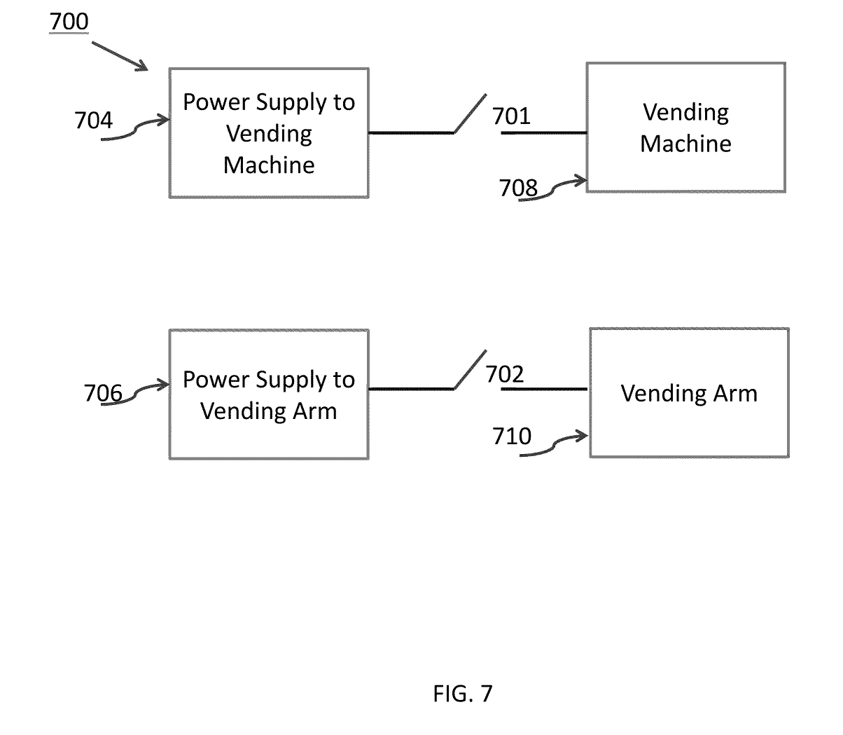

FIG. 7 illustrates exemplary adapter control circuitry 700 for use with an exemplary embodiment of the present invention.

In FIG. 7, the hashed lines are internal circuitry within an exemplary vending machine adapter module. Hashed box 712, for example, is internal circuitry that connects the power supply to the vending machine 704 to the vending machine 708. Hashed box 714, for example, is internal circuitry that connects the power supply to the vending arm 706 to the vending arm 710. Circuit 712 comprises switch 701, and circuit 714 comprises switch 702.

When the vending machine adapter module receives instructions to enable or disable power to the vending machine, logic circuit 712 closes the logic switch 701 to execute the instructions. When the vending machine adapter module receives instructions to enable vending, logic circuit 714 closes the logic switch 702 to execute the instructions.

FIG. 8 illustrates an exemplary computer architecture 800 for use with an exemplary embodiment of the present invention.

The present invention comprises various computing entities that may have an architecture according to exemplary architecture 800. One embodiment of architecture 800 comprises a system bus 820 for communicating information, and a processor 810 coupled to bus 820 for processing information. Architecture 800 further comprises a random access memory (RAM) or other dynamic storage device 825 (referred to herein as main memory), coupled to bus 820 for storing information and instructions to be executed by processor 810. One or more lines of software code based on Java, PhP, SQL may be stored in main memory for execution. Main memory 825 also may be used for storing temporary variables or other intermediate information during execution of instructions by processor 810. Architecture 800 may also include a read only memory (ROM) and/or other static storage device 826 coupled to bus 820 for storing static information and instructions used by processor 810.

A data storage device 825 such as a magnetic disk or optical disc and its corresponding drive may also be coupled to architecture 800 for storing information and instructions. Architecture 800 can also be coupled to a second I/O bus 850 via an I/O interface 830. A plurality of I/O devices may be coupled to I/O bus 850, including a display device 843, an input device (e.g., an alphanumeric input device 842 and/or a cursor control device 841).

The communication device 840 allows for access to other computers (e.g., servers or clients) via a network. The communication device 840 may comprise one or more modems, network interface cards, wireless network interfaces or other interface devices, such as those used for coupling to Ethernet, token ring, or other types of networks.

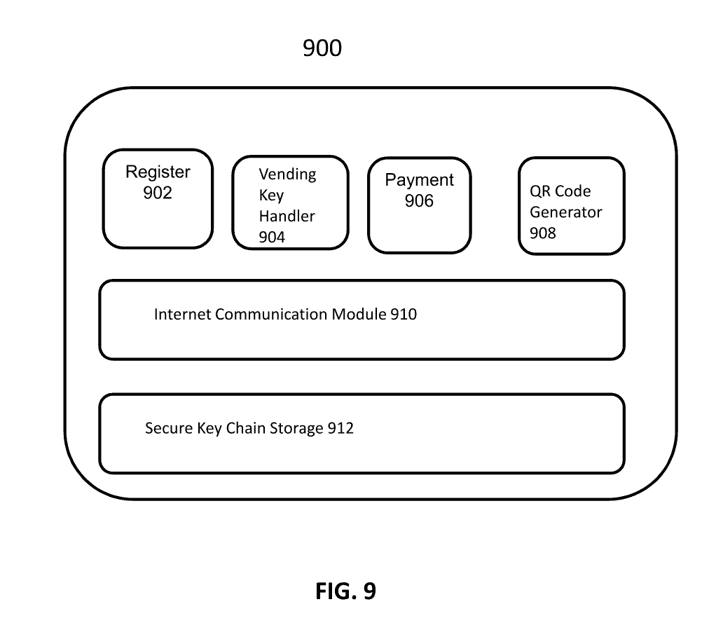

FIG. 9 illustrates a block diagram of merchant side application 900 according to an exemplary embodiment of the present invention.

In FIG. 9, merchant side application 900 may be a software application at a merchant location wherein the user wishes to register and pay for vended products. Merchant side application 900 includes a registration module for registering user; vending key handler 904 for handling the vending key; payment module 906 for receiving payments; QR Code Generator 908 for using the vending key to generate a QR code; Internet communication module 910 and secure key chain storage 912.

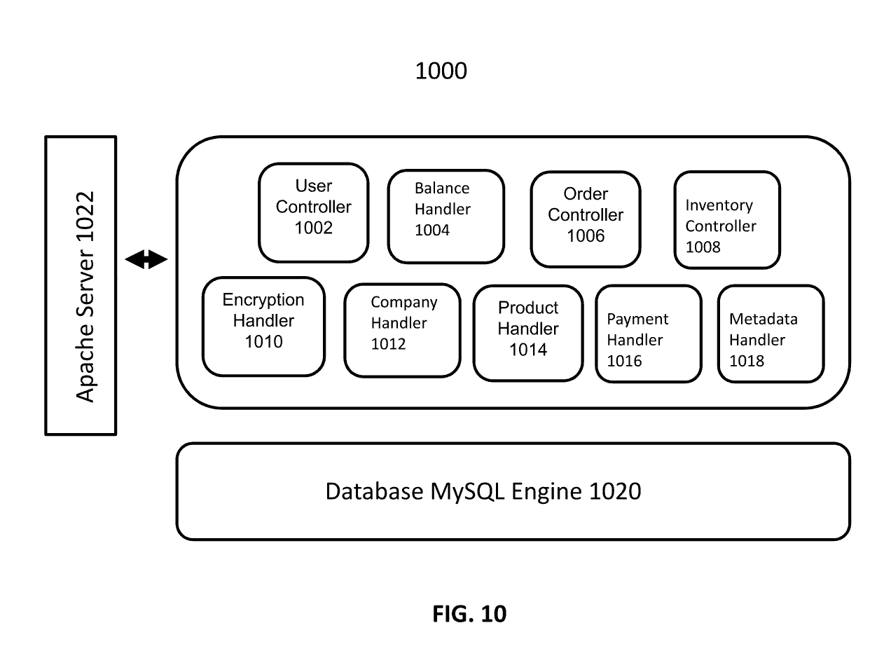

FIG. 10 illustrates a block diagram of remote server side application 1000 according to an exemplary embodiment of the present invention.

In FIG. 10, remote server side application 1000 may be a software application residing at the remote server system 108. Remote server side application 1000 comprises server 1022, in this case, an Apache server; user controller 1002; balance handler 1004 for determining user balances; order controller 1006; inventory controller 1008; encryption handler 1010; company handler 1012; product handler 1014; payment handler 1016; metadata handler 108; as well as database engine 1020.

While the above is a complete description of exemplary specific embodiments of the invention, additional embodiments are also possible. Thus, the above description should not be taken as limiting the scope of the invention, which is defined by the appended claims along with their full scope of equivalents.

What is claimed is:

1. A vending system, comprising:
a vending machine adapter module communicably coupled to a vending machine, the vending machine adapter module configured to vend from the vending machine any one of laundry, water, beverages and food;
a vending service adapted to issue and track vending credits upon receipt of payment for purchasing a product from said vending machine;
a remote server communicably coupled to the vending machine adapter module;
a client computing device configured to communicate a consumer profile of a user to the remote server and/or vending service, the consumer profile including personal information for registering the user and/or the consumer profile including a product type to be dispensed from said vending machine;
wherein responsive to a user request, the vending machine adapter module is adapted to send a product vend request signal to the remote server, wherein said product vend request signal is based on a vending key generated or stored by said client computing device;
wherein responsive to said product vend request signal, the remote server is configured to communicate a vending authorization signal based on vending credits at the vending service; wherein said vending machine adapter module comprises vending control circuitry configured to vend the any one of laundry, water, beverages and food upon receipt of said vending authorization signal from the remote server.

2. The vending system of claim 1 wherein the vending machine adapter module further includes scan circuitry configured to scan a code displayed by the client computing device to generate the product vend request signal, wherein said code is based on the vending key.

3. The vending system of claim 1 wherein said displayed code is a QR code.

4. The vending system of claim 1 wherein said client computing device is configured to download the vending key from the remote server upon receipt of an activation code at the client computing device.

5. The vending system of claim 1 wherein said client computing device uses the vending key to generate a QR code.

6. The vending system of claim 1, wherein the vending machine adapter module comprises
Wi-Fi communication circuitry configured to use an Internet router to transmit vending requests to the remote server and receive vending authorization instructions from the vending service;
the scan circuitry configured to scan a code that identifies vending credits;
Bluetooth communication circuitry configured to detect and identify the client computing device and receive vending requests from the client computing device;
power supply control circuitry configured to enable or disable power to the vending machine in response to instructions received from the remote server;
a sensor network configured to monitor the quality of one of laundry, water, beverages and food; and
vending control circuitry configured to enable vending of one of a product or service vended by the vending machine, the enabling of vending in response to instructions received from one of the remote server or the vending service.

7. The vending system of claim 1, further comprising a sensor network communicably coupled to the vending adapter module and data collected by the sensor network is transmitted to the remote server.

8. The vending system of claim 7, wherein a sensor of the sensor network is one of a quality monitor, an inventory monitor, a motion detector, a consumption meter, a vending sensor, and an environmental sensor.

9. A method comprising:
providing a vending machine adapter module communicably coupled to a vending machine, the vending machine adapter module configured to vend from the vending machine any one of laundry, water, beverages, food and electronics;
using a vending service to issue and track vending credits upon receipt of payment for purchasing a product from said vending machine;
communicably coupling a remote server to the vending machine adapter module;
using a client computing device to communicate a consumer profile of a user to the remote server and/or vending service, the consumer profile including personal information for registering the user and/or the consumer profile including a product type to be dispensed from said vending machine;
wherein responsive to a user request, the vending machine adapter module is adapted to send a product vend request signal to the remote server, wherein said product vend request signal is based on a vending key generated or stored by said client computing device;
wherein responsive to said product vend request signal, the remote server is configured to communicate a vending authorization signal based on vending credits at the vending service; wherein said vending machine adapter module comprises vending control circuitry configured to vend the any one of vended products upon receipt of said vending authorization signal from the remote server.

10. The method of claim 9 further comprising scanning a code displayed by the client computing device, and generating the product vend request signal, wherein said code is based on the vending key.

11. The method of claim 9 wherein said displayed code is a QR code.

12. The method of claim 9 further comprising downloading, on the client computing device, the vending key from the remote server upon receipt of an activation code at the client computing device.

13. The method of claim 9 further comprising using the vending key to generate a QR code.

14. The method of claim, wherein the vending machine adapter module
using Wi-Fi communication to transmit vending requests to the remote server and receive vending authorization instructions from the vending service;
scanning a code that identifies vending credits;
using Bluetooth communication to detect and identify the client computing device and receive vending requests from the client computing device;
enabling or displaying power to the vending machine in response to instructions received from the remote server;
using a sensor network configured to monitor the quality of one of laundry, water, beverages and food; and
enable vending of one of a product or service vended by the vending machine, the enabling of vending in response to instructions received from one of the remote server or the vending service.
